(19) United States
(12) Patent Application Publication
(10) Pub. No.: US 2026/0233598 A1
(43) Pub. Date: Aug. 13, 2026

(54) POWER UNIT FOR A FRONT DRIVE VEHICLE

(71) Applicant: Ford Global Technologies, LLC, Dearborn, MI (US)

(72) Inventors: Steven Klurfeld, Livonia, MI (US); Steven Anatole Frait, Milan, MI (US); Bryant L. Poynter, Redford, MI (US)

(21) Appl. No.: 19/051,063

(22) Filed: Feb. 11, 2025

(51) Int. Cl. B60K 6/40; B60K 6/50

(52) U.S. Cl. CPC B60K 6/40; B60K 6/50

(57) ABSTRACT

Methods and systems are provided for a powertrain for a vehicle. In one example, a powertrain may include a powertrain an internal combustion engine positioned longitudinally to a vehicle and proximally to a front drive axle, a generator positioned longitudinally to the vehicle and distally to the front drive axle and coupled to the internal combustion engine, an electric motor positioned transversely to the vehicle and interposed between the internal combustion engine and the generator, and a transmission arm assembly comprising at least one gear reduction and at least one chain reduction, where the transmission arm assembly is configured to transfer torque between the electric motor and a differential arranged on the front drive axle.

### FIELD

The present description relates generally to methods and systems for integrating an electric motor and generator into a vehicle frame of a vehicle with front independent suspension.

### BACKGROUND/SUMMARY

A plug-in hybrid electric vehicle may be designed by adding a front electric power unit and traction battery, such as for a battery electric vehicle or by adding the front electric power unit to an existing internal combustion engine (ICE) vehicle. The front electric power unit may include a traction motor and a generator.

For example, an internal combustion engine (ICE) may be configured to drive the generator using the combustion of a fuel source such as gasoline, and the generator may convert mechanical energy recovered through regenerative braking into electrical energy, which may be stored within a traction battery. The traction motor may be configured to drive front wheels of the vehicle using electrical energy stored in the traction battery or supplied directly from the generator. Modifying existing ICE vehicles may be advantageous due to the potential to avoid vehicle redesign and for reusing or cross-purposing of existing vehicle components. However, for ICE vehicles with front independent suspension units, packaging space at the front of the vehicle is limited, and it is challenging to package a front electric power unit of sufficient size for a given vehicle application. Similarly, for battery electric vehicle without an ICE, other packaging issues may arise that also limit space at the front of the vehicle, such as by providing a frunk.

One approach to adding a front electric power unit to a vehicle includes placing a traction motor parallel to a generator, and optionally in line with an ICE if equipped. The approach uses a driveshaft to transmit torque (e.g., from the ICE) to the front wheels via a hypoid gear, which has the disadvantage of higher power losses than parallel gear and chain reductions. Another approach includes positioning a front electric power unit under the engine. However, such configurations rely on long motors, and use shorter half shafts and higher CV joint angles, which may be undesirable.

In one example, the issues described above may be addressed by a powertrain comprising a generator positioned longitudinally to the vehicle and distally to the front drive axle; an electric motor positioned transversely to the vehicle, the electric motor comprising a rotor shaft having a rotor shaft axis offset from and perpendicular to the generator axis; and a transmission arm assembly comprising at least one gear reduction and at least one chain reduction, where the transmission arm assembly is configured to transfer torque between the rotor shaft and a differential arranged on the front drive axle.

In this way, a front electric power unit may fit within the frame of existing front independent suspension vehicles without substantial redesign. The powertrain described above allows the lengths of the traction motor and the generator to be adjusted independently, which may allow the front electric power unit to be implemented across a wide variety of vehicles without substantial reconfiguration to fit in the engine cavity.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 is a schematic depiction of a vehicle and powertrain.

FIG. 2 is a perspective view of an example of a powertrain including an internal combustion engine (ICE), electric motor and generator that may be included in the vehicle of FIG. 1.

FIG. 3 is a cross-sectional view of the powertrain of FIG. 2 taken along a first cross-sectional plane.

FIG. 4 is a cross-sectional view of the powertrain of FIG. 2 taken along a second cross-sectional plane.

FIG. 5 is a cross-sectional view of the powertrain of FIG. 2 taken along a third cross-sectional plane.

FIG. 6 is a perspective view of a transmission arm assembly of the powertrain of FIG. 2.

FIG. 7 is an underside view of an example of a vehicle frame and powertrain of the present disclosure.

FIG. 8 is a partial side view of the vehicle frame and powertrain of FIG. 7.

FIG. 9 is a flow chart of a method for building a hybrid vehicle of the type that is illustrated in FIG. 1.

### DETAILED DESCRIPTION

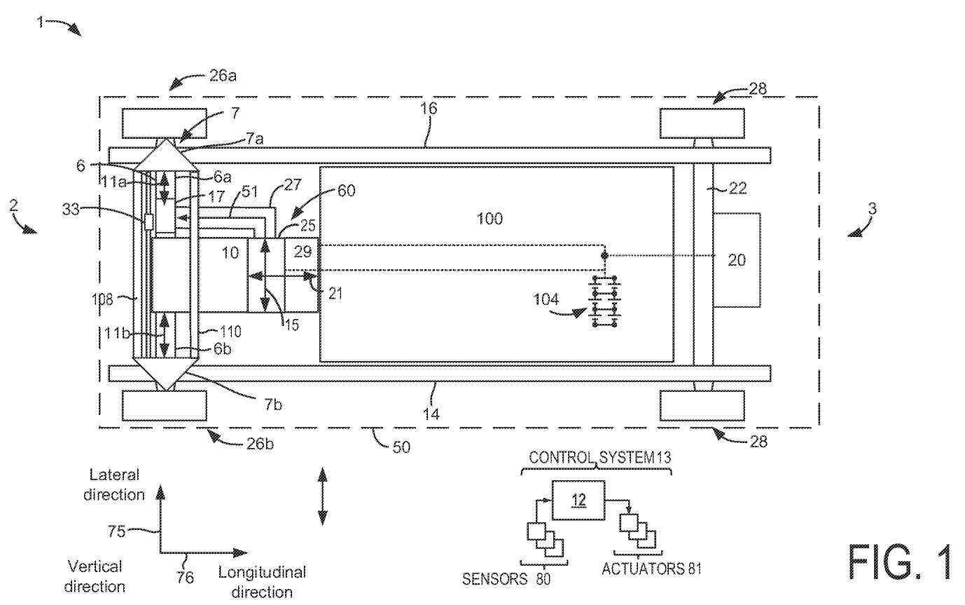

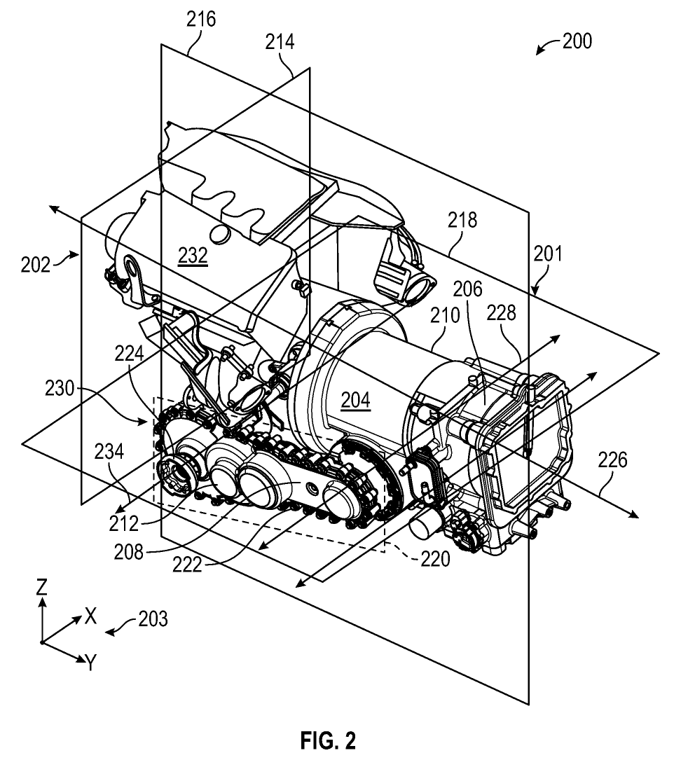

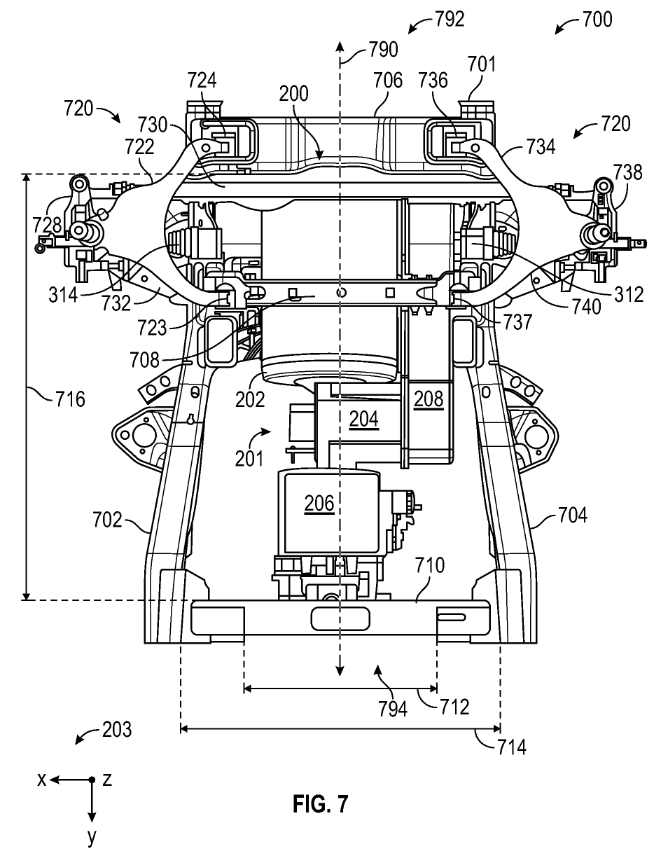

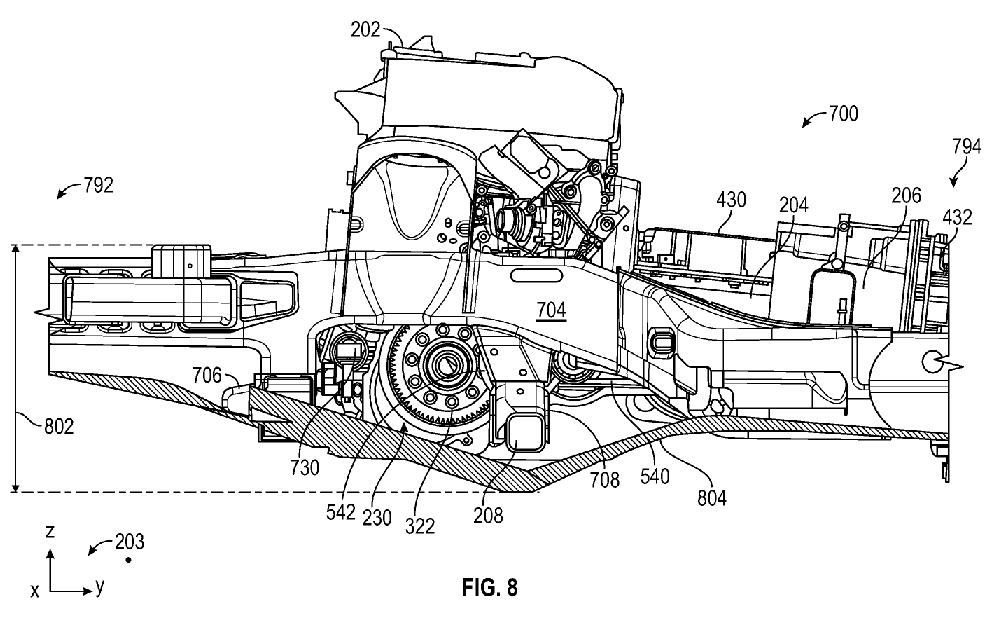

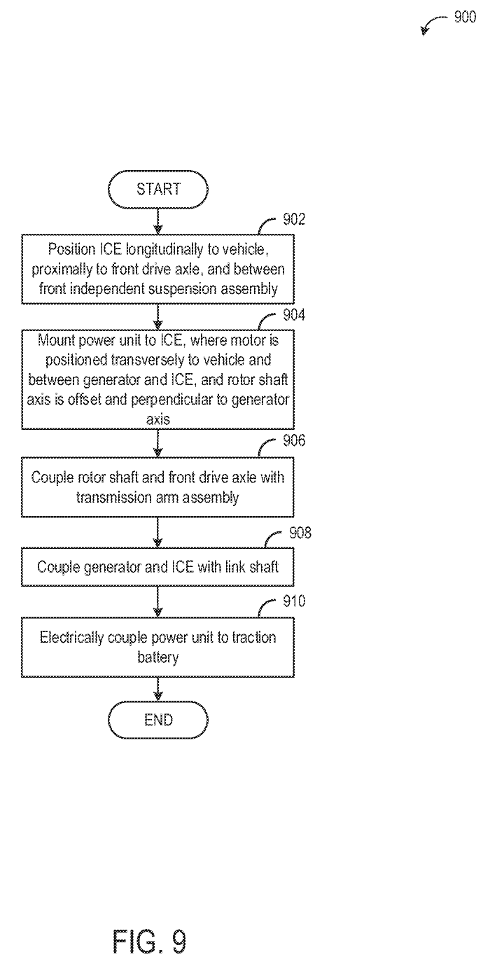

The present description is related to a hybrid electric vehicle with front electric power unit that is configured to fit in the envelope of existing front independent suspension internal vehicles, without modification to engine placement if so equipped. The disclosed parallel power unit provides a compact design, which can accommodate variously sized motors and generators, and increased overall steady state mechanical efficiency over existing approaches. The hybrid vehicle, as shown in FIG. 1, may include an electrified powertrain comprising an optional ICE positioned longitudinally to the vehicle and proximally to a front drive axle, and a parallel power unit including a generator and a traction motor configured to transfer power to front wheels by sequential combination of parallel gear reductions and chain drives, ending in a differential close to the centerline of the front wheels. An example powertrain including the parallel power unit of the present disclosures is illustrated in FIGS. 2-6. As one example, the traction motor may be mounted on the back of the ICE, turned at a right angle relative to a crankshaft of the engine. A transmission arm allows torque to be transferred from the traction motor to the front drive axle via a plurality of parallel shafts, at least one gear reduction, and at least one chain reduction. The generator may be rotatably coupled to the engine by a link shaft which extends perpendicularly relative to the rotor of the motor. FIG. 7 shows an underside view of an example of the powertrain integrated into a frame of a front independent suspension vehicle of the present disclosure, and FIG. 8 shows the example of FIG. 7 from a side view. The hybrid vehicle may be fabricated according to the method of FIG. 9. FIGS. 2-8 are shown approximately to scale.

Referring to FIG. 1, a schematic diagram of 100 shows an example of a vehicle, which may be a hybrid vehicle or a battery electric vehicle. While FIG. 1 illustrates a hybrid vehicle 1 that includes a chassis 50, a front side 2, and a rear side 3, a battery electric vehicle may be used without an engine and having a storage box, such as a frunk, positioned where the engine is illustrated.

Hybrid vehicle 1 may travel in a forward direction with front side 2 leading the hybrid vehicle when the hybrid vehicle is engaged in a forward gear. Hybrid vehicle 1 may travel in a reverse direction with rear side 3 leading the hybrid vehicle when the hybrid vehicle is engaged in a reverse gear. Lateral direction of hybrid vehicle 1 is indicated by arrows 75 and a longitudinal direction of hybrid vehicle 1 is indicated by arrows 76.

Hybrid vehicle 1 includes a front drive axle 6 with a first front wheel 26a and a second front wheel 26b. A differential 17 is arranged on the front drive axle 6 between a first half shaft 6a and a second half shaft 6b. Hybrid vehicle 1 includes a rear axle 22 and rear wheels 28. The first half shaft 6a may rotate around a first rotational axis 11a to provide torque to the first front wheel 26a. The second half shaft 6b may rotate around a second rotational axis 11b to provide torque to the second front wheel 26b. Hybrid vehicle 1 includes a vehicle frame with a first frame rail 14 (e.g., a left-hand side frame rail) and a second frame rail 16 (e.g., a right-hand side frame rail). The first frame rail 14 and the second frame rail 16 extend between the front drive axle and the rear axle 22. The frame may include a first bar 108 and a second bar 110, e.g., cross members, that extend between the first frame rail 14 and the second frame rail 16. The first bar 108 and the second bar 110 may be parallel to the first half shaft 6a and the second half shaft 6b. The first frame rail 14 and second frame rail 16 may extend beyond the front drive axle and the rear axle, or the first frame rail 14 and second frame rail 16 may run short of the front drive axle and the rear axle. The first frame rail 14 and the second frame rail 16 are configured to support chassis 50 and the frame rails may be coupled to the front drive axle 6 and the rear axle 22.

Hybrid vehicle 1 includes a front independent suspension assembly 7 configured to allow the first front wheels 26a and the second front wheel 26b to move vertically independent of the each other. The front independent suspension assembly 7 may include a first independent suspension unit 7a and a second independent suspension unit 7b respectively coupling the first front wheel 26a and the second front wheel 26b to the first bar 108 and the second bar 110. Additionally, first frame rail 14 and second frame rail 16 are configured to support traction battery 100, which includes a housing or case that continuously extends between first frame rail 14 and second frame rail 16. Traction battery includes a plurality of battery cells 104 that are arranged and electrically coupled in series and/or in parallel.

Hybrid vehicle 1 includes an ICE 10 positioned longitudinally to the vehicle, proximally to the front drive axle 6, and between the front independent suspension assembly 7, and a parallel power unit 60 that is mounted to the ICE 10 in front of the traction battery 100. The parallel power unit 60 is configured to generate electric power via an output of the ICE 10, and to supply propulsive effort to the first front wheel 26a and the second front wheel 26b via an output of the traction battery 100. Parallel power unit 60 includes a traction motor 25, a generator 29 and a transmission arm assembly 27. The generator 29 is positioned longitudinally to the vehicle and distally to the front drive axle 6, and coupled to the ICE 10 along a generator axis 21, e.g., a rotational axis of the generator 29. The traction motor 25, e.g., an electric motor, is positioned transversely to the vehicle, between the ICE 10 and a distal end of the generator 29. A rotor shaft axis 15, e.g., a rotational axis of the motor, is offset from and perpendicular to the generator axis 21. A transmission arm assembly 27 is configured to transfer torque between the traction motor 25 and the differential 17. Parallel power unit 60 provides a torque path 51 as indicated by an arrow. The torque path 51 may extend from the traction motor 25 through the transmission arm assembly 27 to the differential 17. A plurality of views of an example of the parallel power unit 60 are shown in FIGS. 2-8.

The first front wheel 26a and the second front wheel 26b may pivot independently when urged to do so via steering linkage 33. Steering linkage 33 may be mechanically coupled to a steering wheel, or alternatively, a position of steering linkage 33 may be adjusted via an electric motor. Thus, the direction of travel of hybrid vehicle 1 may be changed via adjusting a position of steering linkage 33 and the front wheels. Torque from the parallel power unit 60 may rotate front wheels 26.

The rear axle 22 may include a rear power unit 20 with an electric motor generator and a gear set. Electric machines in the parallel power unit 60 and rear power unit 20 may receive electric power from traction battery 100. Further, when operating in a generator mode, ICE 10, and rear power unit 20 may supply electric charge to traction battery 100. Rear power unit 20 may rotate rear wheels 28.

Hybrid vehicle 1 may be controlled at least partially by a control system 13 including controller 12. Controller 12 may receive various signals from sensors 80 coupled to hybrid vehicle 1, and send control signals to various actuators 81 coupled to the vehicle. The various sensors may include, for example, various temperature, pressure, and air-fuel ratio sensors. The various actuators may include, for example, various valves, throttles, and fuel injectors. One example actuator may include a traction motor inverter starter control (ISC) unit and a generator ISC. The traction motor ISC may be a small motor configured to position the throttle for a plurality of motor usage modes. The traction motor ISC may be controlled according to directions stored within controller 12. One or more sensors may be integrated within the motor to assess metrics such as temperature and output. The generator ISC may similarly control the function of the generator according to directions stored within the controller 12 in response. One or more sensors may be integrated within the generator to assess metrics such as temperature and output. Controller 12 may be a microcomputer, including a microprocessor unit, input/output ports, an electronic storage medium for executable programs and calibration values. Controller 12 may be programmed with computer readable data representing instructions executable to perform the methods described below as well as other variants that are anticipated but not specifically listed.

FIGS. 2-8 include a Cartesian coordinate system 203 to orient the views. The coordinate system may be arranged with respect to the position of parts as would be assembled into the hybrid vehicle of FIG. 1. The z-axis of coordinate system 203 may be a vertical axis (e.g., parallel to a gravitational axis), the x-axis of coordinate system 203 may be a lateral axis, and/or the y-axis of coordinate system 203 may be a longitudinal axis, in one example. However, the axes may have other orientations, in other examples. When referencing direction, positive may refer to in the direction of the arrow of the x-axis, y-axis, and z-axis and negative may refer to in the opposite direction of the arrow of the x-axis, y-axis, and z-axis. A filled circle may represent an arrow and axis facing toward, or positive to, a view. An unfilled circle may represent an arrow and an axis facing away, or negative to, a view. Further, FIGS. 2-8 are drawn to scale, though other relative dimensions may be used.

FIG. 2 is a perspective view of a powertrain 200. The powertrain 200 includes a parallel power unit 201 and an ICE 202 (shown schematically throughout), which may respectively be examples of the parallel power unit 60 and the ICE 10 of FIG. 1. The parallel power unit 201 may include a motor 204, a generator 206, and a transmission arm assembly 208. Generator 206 may supply electrical charge to traction battery 100 shown in FIG. 1 and/or motor 204 when generator 206 is rotated via ICE 202. Generator 206 is not mechanically coupled to motor 204, such as to not be driven by and not receive rotational energy via torque from the motor 204.

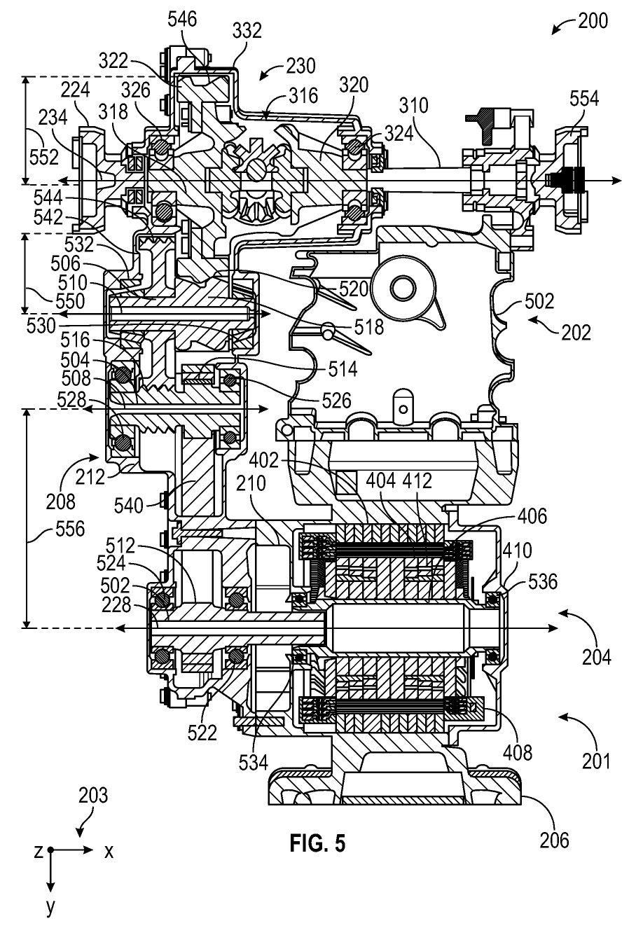

Motor 204 is a traction motor that may provide propulsive effort to front wheels 26a, 26b as shown in FIG. 1 via front drive axle 6. The motor 204 may be coupled to the differential 230 via the transmission arm assembly 208. The differential 230 may be similar to the differential 17 as shown in FIG. 1. A first coupling 224 for a half shaft is rotatably mounted to the differential 230, and a similar coupling 554 (in FIG. 5) is arranged on the opposing side of the powertrain 200 from the first coupling 224 relative to a longitudinal centerline extending coaxial with a generator axis 226. A rotational axis of the motor 204, e.g., centered on a rotor of the motor 204, herein a rotor axis 228, intersects perpendicularly with the generator axis 226. A first rotational axis 234 of the axle, e.g., centered on the first coupling 224, is parallel with the rotor axis 228.

The parallel power unit 201 may receive an input torque via ICE 202 and convert the torque to electric charge via the generator 206. The electric charge may be delivered to the motor 204 and/or the traction battery 100 in FIG. 1.

The motor 204 and the generator 206 may be housed in a power component case 210. The transmission arm assembly 208 may be enclosed by a drivetrain housing 212 that is fastened to the power component case 210 and a block 232 of the ICE 202 via plurality of fasteners 222, such as bolts.

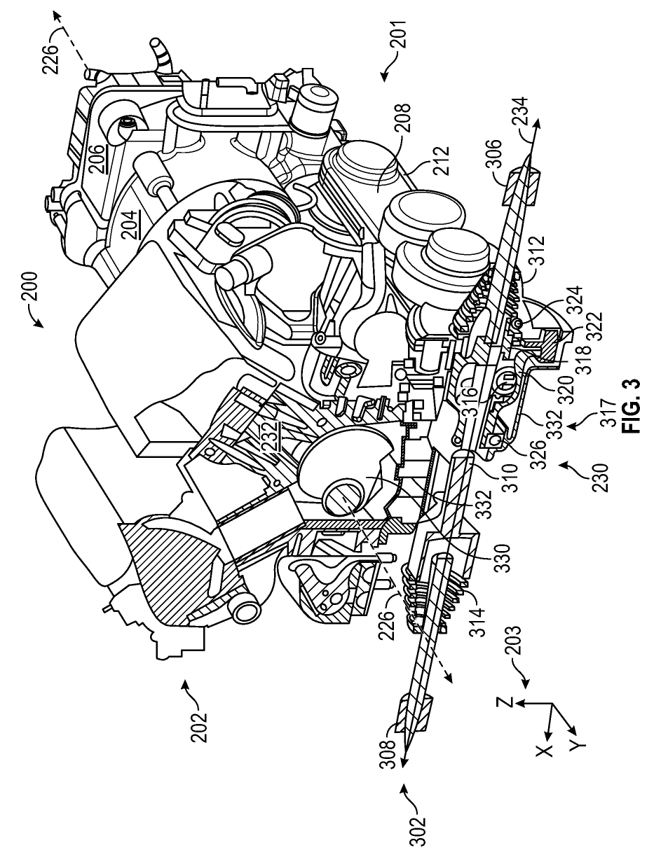

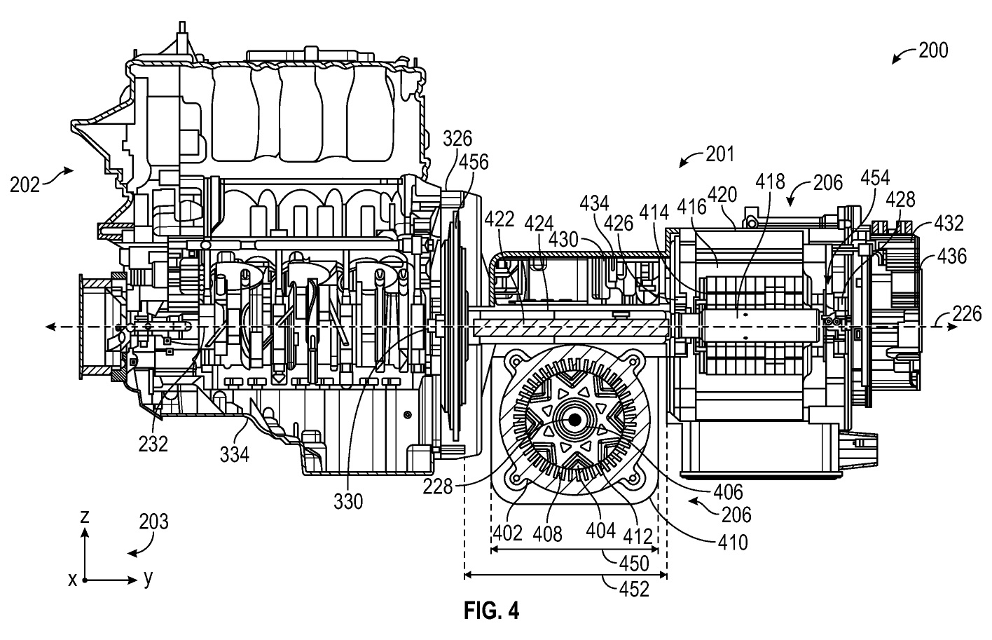

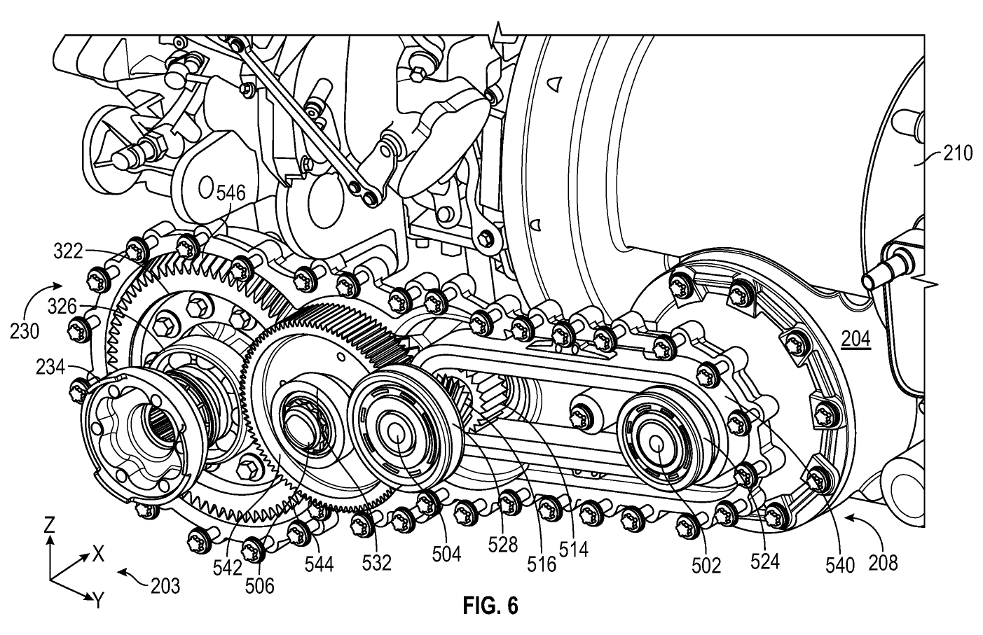

A plurality of planes through which cross sectional views of the powertrain 200 are shown in figures to follow are illustrated. A first plane 214 is a lateral cross section through a front portion of the ICE 202 and a front drive axle, and is shown in FIG. 3. A second plane 216 is a longitudinal cross section through the ICE 202, motor 204, and generator 206, and is shown in FIG. 4. A third plane 218 is a vertical cross section through the powertrain 200, and is shown in FIG. 5. Area 220 is shown enlarged and with the drivetrain housing 212 removed in in FIG. 6.

FIG. 3 depicts a perspective view of the powertrain 200 including a lateral cross section through the first plane 214 in FIG. 2. The cross section cuts through the differential 230 and a front drive axle 302, which may be an example of the front drive axle 6 in FIG. 1. Further, the cross section cuts through the block 232 of the ICE 202. Components of the powertrain 200 introduced in FIG. 2 that are visible in FIG. 3 are numbered the same and will not be introduced.

The front drive axle 302 includes a first half shaft 306, a second half shaft 308, and an intermediate shaft 310. The first half shaft 306 is coupled to the differential 230 via a first CV joint 312. The second half shaft 308 is coupled to the intermediate shaft 310 via a second CV joint 314, and the intermediate shaft 310 to the differential 230. In one example, the parallel power unit 201 allows for the use of standard production half shafts as to length and position due to the compact and efficient use of space. For example, the parallel power unit 201 may be installed in some existing vehicle frames while retaining the production half shaft position and length.

The differential 230 is configured to transfer torque from the transmission arm assembly 208 to the first half shaft 306 and the second half shaft 308. The differential 230 may include a differential gear assembly 316 enclosed within in a differential case assembly 317 including a first case member 318 and a second case member 320. A final reduction gear 322 rotationally couples the transmission arm assembly 208 to the first case member 318, where torque is transferred to the differential gear assembly 316 and to the axle half shafts. In one example, the final reduction gear 322 is bolted directed to the differential case assembly 317. The differential case assembly 317 may be supported by first and second bearings 324, 326. The differential 230 may be enclosed by a differential housing 332, which in some examples may fasten to and/or comprise at least a portion of the drivetrain housing 212.

The cross section through ICE 202 shows a crankshaft 330. The crankshaft 330 may be rotationally coupled to the generator 206, where rotation of the crankshaft 330 drives the generator 206. The cross section further shows an oil pan 334 arranged beneath the block 232 of the ICE 202. The oil pan 334 may be fluidly coupled to a lubrication system which supplies lubricant to the powertrain 200 including the transmission arm assembly 208. In one example, the drivetrain housing 212 is fluidly coupled to the oil pan 334 via the lubrication system, and the transmission arm assembly 208 may utilize splash lubrication. It should be noted that the differential 230 and coupling with the transmission arm assembly 208 is sufficiently compact to clear the oil pan 334. In this way, the parallel power unit 201 may provide an electrified front drive without substantial engine redesign.

FIG. 4 depicts a cross sectional view of the parallel power unit 201 through the second plane 216 in FIG. 2. Many components included in the description of FIGS. 2-3 are visible in FIG. 4 and will not be reintroduced in the description below. The cross sectional view shows the interiors of the ICE 202, motor 204, and the generator 206.

The motor 204 includes a stator 402, a rotor 404, and a rotor shaft 406. The stator 402 may include a plurality of windings 408, and may be fixed to a motor case 410 or housing. The rotor 404 may include a plurality of bars 412, and be coupled to the rotor shaft 406. The rotor shaft 406 rotatably couples the motor 204 to the transmission arm assembly 208. The motor 204 is mounted distally to the ICE 202, where the rotor 404 of the motor 204 may be arranged at a right angle relative to the crankshaft 330 of the ICE 202.

The generator 206 includes an armature 414, a stator 416, and a generator shaft 418. The stator 416 may include copper windings and be fixed to a stator frame 420. The armature 414 may be coupled to the generator shaft 418. The generator shaft 418 rotatably couples the generator 206 to the ICE 202 by way of a link shaft 422. The link shaft 422 may be sized to accommodate a motor of various size, which enables the sizing the motor based on the application without substantial redesign of the parallel power unit 201. In the example of powertrain 200, the link shaft 422 has a first axial length 452 that is greater than a longitudinal width 450 of the motor case 410 or housing of the motor 204. The link shaft 422 may be a cylindrical rod coupled to the crankshaft 330 of the ICE 202. The crankshaft 330 may be coupled to the link shaft 422 by a flywheel 456. Alternatively, the crankshaft 330 may be coupled to the link shaft 422 by a flexplate. The link shaft 422, the crankshaft 330, and the generator shaft 418 may share an axis of rotation, e.g., the generator axis 226. Rotation of the crankshaft 330 rotates the link shaft 422 and the generator shaft 418 coupled thereto in order to generate a current within the generator 206, and the current may be stored in the traction battery 100 in FIG. 1 and/or utilized by motor 204 to propel the vehicle. The rotation of the generator shaft may be supported by bearings 426, 428. The rotor 404 of the motor 204 is arranged at a right angle relative to the generator shaft 418 of the generator 206. The generator 206 may include a resolver and grounding device assembly 454 to prevent electrical discharge through the bearings 426, 428.

The link shaft 422 may be arranged within a link shaft aperture 424. The link shaft aperture 424 may be cylindrical in shape and extend from the ICE 202 through the power component case 210 above the motor 204. The link shaft aperture 424 may be sized to accommodate the link shaft 422.

The powertrain 200 further includes a first inverter switching control (ISC) unit 430 electrically coupled to the motor 204 and a second ISC unit 432 electrically coupled to the generator. The ISC units regulate the idle speed of the powertrain 200, and may include high voltage connectors, low voltage connectors, and one or more control boards. In one example, the first ISC unit 430 may be enclosed in a first ISC housing 434 and the second ISC unit 432 in a second ISC housing 436. In other examples, the powertrain 200 may include an integrated motor and generator inverter switching control. In such an example, the first ISC unit 430 and the second ISC unit 432 may be enclosed in a single, common housing assembly, e.g., first ISC housing 434 or second ISC housing 436, where the ISC units share high voltage connectors, low voltage connectors, and one or more control boards Such an arrangement may reduce the total volume of cooler, DC-link capacitor, EMC filter, and other parts, which may further reduce the overall volume, e.g., footprint, of the power unit and improve space utilization within the vehicle frame.

FIG. 5 depicts a cross sectional view of the powertrain 200 through the third plane 218 in FIG. 3. Many components included in the description of FIGS. 2-4 are visible in FIG. 5 and will not be reintroduced in the description below. The cross sectional view shows the interiors of the motor 204, the transmission arm assembly 208, and the differential 230.

The transmission arm assembly 208 may include a first shaft 502, a second shaft 504, and a third shaft 506. The first shaft 502 may be a motor output shaft which is directly coupled to the rotor shaft 406 of the motor 204. The first shaft 502 may include a first chain interface 512. The second shaft 504 may include a second chain interface 514 and teeth 516. In one example, the third shaft 506 may comprise a drive pinion 518 having teeth 520 in mesh with the final reduction gear 322. The first shaft 502, the second shaft 504, and the third shaft 506 may be centered around parallel axes of rotation. For example, the first shaft 502 rotates around the rotor axis 228 of the motor 204. The second shaft 504 rotates around a second rotational axis 508. The third shaft 506 rotates around a third rotational axis 510. The first shaft 502, the second shaft 504, and the third shaft 506 are arranged in parallel with each other, the intermediate shaft 310, and the first half shaft 306 and the second axle half shaft 308 shown in FIG. 3. The rotor axis 228, the first rotational axis 234, the second rotational axis 508, and the third rotational axis 510 are arranged in parallel with each other and the x-axis. Rotation of the first shaft 502 may be supported by first bearings 522, 524. Rotation of the second shaft 504 may be supported by second bearings 526, 528. Rotation of the third shaft 506 may be supported by third bearings 530, 532. Fourth bearings 534, 536 support rotation of the rotor shaft 406.

The transmission arm assembly 208 may include at least one gear reduction and at least one chain reduction, e.g., a gear ratio and a chain ratio respectively, and is configured to transfer torque between the motor 204 and the differential 230. In the example, a first chain 540 is directly coupled to first chain interface 512 of the first shaft 502 and second chain interface 514 of the second shaft 504. The first chain 540 is configured to transfer torque from the motor 204 to the first shaft 502, and from the first shaft 502 to the second shaft 504. A first gear 542 is mounted on the third shaft 506. The first gear 542 includes teeth 544. The teeth 544 of the first gear 542 are in mesh with the teeth 516 of the second shaft 504. Rotation of the second shaft 504 rotates the first gear 542, thereby driving rotation of the third shaft 506. The teeth 520 of the drive pinion 518 are in mesh with teeth 546 of the final reduction gear 322. Rotation of the third shaft 506 rotates the drive pinion 518, transferring torque between the third shaft 506 and the first case member 318 via the final reduction gear 322. In the example, the first gear 542 has first radius 550 and the final reduction gear 322 has a second radius 552, where the first radius is 550 is smaller than the second radius 552. The chain has a length 556, which may be adjusted to accommodate one or more of a differently sized motor, additional gears, differently sized gears, and shaft position.

The disclosed parallel power unit including the transmission arm assembly, such as shown in the examples above, provides increased overall steady state mechanical efficiency over existing approaches. In this example, overall efficiency is measured by dividing the output torque by the product of the input torque and the gear ratio, and multiplying by 100. For example, an electric transfer drive unit which is configured to transmit torque from the existing ICE to the front wheels via a hypoid gear, may have higher power losses than the disclosed parallel power unit. By some estimates, electric transfer drive units are approximately 86.9% efficient, whereas the disclosed assembly with the use of parallel gear and chain reductions may approach upwards of 94% efficiency. Under engine front power units of the type that use a long motor design may approach the efficiency of the disclosed parallel power unit, e.g., approximately 93%; however, long motor power units typically use a higher ratio reduction to compensate for the long motor, which may be undesirable for some applications.

FIG. 6 depicts an enlarged perspective view of the area 220 of the powertrain 200 in FIG. 2. In the enlarged view, the drivetrain housing 212 is removed to show the gear reduction and chain components of the transmission arm assembly 208. Components of the powertrain 200 that are visible in FIG. 5 are numbered the same and are not introduced. The disclosed parallel power unit, with the motor offset and perpendicular to the generator, allows the generator, the motor and the gear reductions to be modified independently of each other. As shown in the example, the transmission arm assembly 208 includes the first gear 542, the final reduction gear 322, and the first chain 540, however in other examples, other arrangements are possible. For example, a parallel power unit including a larger motor may include one or more additional gears and/or chains, and corresponding shafts. Similarly, a parallel power unit including a larger generator may include one or more additional gears and/or chains, and corresponding shafts. Additionally, or alternatively, one or more gears having differently sized radii may be utilized to transfer torque between a differently sized motor and the front drive axle.

FIG. 7 and FIG. 8 shows an example of a vehicle 700 including the powertrain 200 comprising the ICE 202 and the parallel power unit 201. The vehicle 700 may be an example of the hybrid vehicle 1 shown in FIG. 1. FIG. 7 shows the vehicle 700 viewed from the underside to illustrate a spatial arrangement of the powertrain 200 relative to a vehicle frame 701 and a front independent suspension assembly 720. FIG. 8 shows the vehicle 700 viewed from the side with the front independent suspension assembly 720 omitted to illustrate a spatial arrangement of the powertrain 200 relative to the vehicle frame 701, steering rack 730, and other components of the vehicle 700. Components of the powertrain 200 that are visible in FIGS. 7-8 are numbered the same and are not introduced.

Turning first to FIG. 7, a longitudinal centerline 790 bisects the vehicle 700 into approximately equal halves. The vehicle 700 includes a front side 792 and a rear side 794. The vehicle may travel in a forward direction with front side 792 leading the hybrid vehicle when the hybrid vehicle is engaged in a forward gear. Likewise, the vehicle may travel in a reverse direction with rear side 794 leading the vehicle when the hybrid vehicle is engaged in a reverse gear.

The vehicle 700 includes a vehicle frame 701 comprising a first frame rail 702 and a second frame rail 704. The first frame rail 702 and the second frame rail 704 extend longitudinally between a first cross member 706, a second cross member 708, and a third cross member 710. The first frame rail 702 and the second frame rail 704 are angled inward towards the longitudinal centerline 790 in the negative y-direction. In other words, the vehicle frame 701 narrows towards the front side 792 and widens towards the rear side 794. For example, a cavity or void may be formed between the first frame rail 702 and the second frame rail 704 of the vehicle frame 701 which has a first lateral dimension 712 proximate to the front side 792, and a larger, second lateral dimension 714 proximate to the rear side 794. The cavity between the vehicle frame 701 is approximately the first lateral dimension 712 between the first cross member 706 and the second cross member 708, increasing in lateral width up to the third cross member 710 where the cavity is the second lateral dimension 714. The cavity formed between the first frame rail 702 and the second frame rail 704 may extend longitudinally a first longitudinal dimension 716, which is greater than the first lateral dimension 712 and the second lateral dimension 714.

The vehicle includes a front independent suspension assembly 720 that is configured to couple front wheels of the vehicle to the vehicle frame 701. The front independent suspension assembly 720 may be one example of the front independent suspension assembly 7 shown in FIG. 1. The front independent suspension assembly 720 includes a first control arm 722 arranged on the left side of the longitudinal centerline 790, and a second control arm 734 arranged on the right side. The first control arm 722 is coupled to the first cross member 706 via a first strut 724, and to the second cross member 708 via a second strut 726. The first control arm 722 is configured to couple to a first front wheel via a first wheel assembly 728. The first wheel assembly 728 may be coupled to a steering rack 730. A corresponding third control arm 732 may be aligned vertically above (e.g., behind) and substantially overlap the first control arm 722 along the z-axis. The third control arm 732 may be similarly coupled to the vehicle frame 701, the first wheel assembly 728 and the steering rack 730. The second control arm 734 is coupled to the first cross member 706 via a third strut 736 and to the second cross member 708 via a fourth strut 737. The second control arm 734 is configured to couple to a second front wheel via a second wheel assembly 738. The second wheel assembly 738 may be coupled to the steering rack 730. A corresponding fourth control arm 740 may be aligned vertically above (e.g., behind) and substantially overlap the second control arm 734 along the z-axis. The fourth control arm 740 may be similarly coupled to the vehicle frame 701, the second wheel assembly 738 and the steering rack 730.

The parallel power unit 201 fits within the vehicle frame 701, coupled to the ICE 202 without interfering with the front independent suspension assembly 720 or the steering rack 730. The configuration of the parallel power unit 201 provides a compact design which allows for increasing the size of the motor or the generator. For example, the longitudinal positon of the generator 206 and the longitudinal length of the transmission arm assembly 208 may be increased in the positive y-direction to accommodate a larger motor, without increasing a lateral dimension of the parallel power unit or interfering with the vehicle frame 701. Similarly, the longitudinal length of the transmission arm assembly 208 may be increased in the positive y-direction to accommodate a larger generator, without increasing the lateral dimension of the parallel power unit 201 or interfering with the vehicle frame 701. Further, as shown in FIG. 8, a vertical dimension 802 of the parallel power unit 201 clears (e.g., does not extend beyond) a vulnerable component plane 804, and the differential 230 is spaced apart from the steering rack 730.

Turning now to FIG. 9, a method for building and assembling a hybrid vehicle is shown. The method of FIG. 9 may be included as executable instructions in non-transitory memory of one or more controllers. Further, the method of FIG. 9 may be performed via humans and/or an automated assembly system. The method of FIG. 9 may also include actions taken in the physical world to transform operating states of the system of FIGS. 1-8.

At 902, method 900 includes positioning an internal combustion engine longitudinally to a vehicle, proximally to a front drive axle, and between a front independent suspension assembly.

At 904, the method includes mounting a power unit to the internal combustion engine, where the power unit includes an electric motor positioned transversely to the vehicle and between a generator and the internal combustion engine, and a rotor shaft which is offset and perpendicular to the generator axis.

At 906, the method includes coupling the rotor shaft to the front drive axle with a transmission arm assembly. The transmission arm assembly may include at least one gear reduction and at least one chain reduction. In one example, the transmission arm assembly may include a chain reduction, a first gear, and a final reduction gear, such as shown in FIGS. 2-8.

At 908, the method may include coupling the generator and ICE with a link shaft. The link shaft may pass through a common housing shared by the electric motor and generator. The link shaft may be arranged perpendicular to the rotor axis.

At 910, the method may include electrically coupling the power unit to a traction battery. By electrically coupling the traction battery to the power unit, the power unit may receive electric power from the traction battery, and the power unit may supply electric power to the traction battery. From 910, the method may exit.

In other examples, the disclosed parallel power unit may include a differently configured transmission arm assembly than the examples described herein. For example, the transmission arm assembly may include a single gear reduction and a single chain reduction. Such configurations may include the gear directly coupled to the motor and the chain coupled to the transmission, or the opposite arrangement. The transmission arm assembly may include two gears and a single chain. Such configurations may include a chain-gear-gear configuration coupling the motor to the transmission, gear-chain-gear, or gear-gear-chain arrangements. In further examples, the transmission arm assembly may include two chains and a single gear. Such configurations may include a chain-chain-gear configuration coupling the motor to the transmission, chain-gear-chain, or gear-chain-chain arrangements. Other examples may include a transmission arm assembly comprising two chain reductions (or more) and no gear reductions, or two gear reductions (or more) and no chain reductions.

In this way, by positioning the electric motor with the rotor arranged at a right angle relative to the generator axis and crankshaft of the ICE, the parallel power unit achieves a compact footprint while allowing for independent sizing of the motor and/or the generator. Additional and/or differently sized gears and/or chain reduction elements may be added to the transmission arm assembly to accommodate a larger or smaller electric motor and/or generator without interfering with the vehicle frame and suspension. As a result, the disclosed parallel power unit may enable electrification of existing ICE vehicles without substantial redesign. The technical effect of the disclosure is a front electric drive unit with greater overall steady state mechanical efficiency over existing approaches.

The disclosure also provides support for a powertrain, comprising: an internal combustion engine positioned longitudinally to a vehicle and proximally to a front drive axle, a generator positioned longitudinally to the vehicle and distally to the front drive axle and coupled to the internal combustion engine, where a coupling between the internal combustion engine and the generator defines a generator axis, an electric motor positioned transversely to the vehicle and interposed between the internal combustion engine and the generator, the electric motor comprising a rotor shaft having a rotor shaft axis offset from and perpendicular to the generator axis, and a transmission arm assembly comprising at least one gear reduction and at least one chain reduction, where the transmission arm assembly is configured to transfer torque between the electric motor and a differential arranged on the front drive axle. In a first example of the system, the vehicle comprises a front independent suspension assembly. In a second example of the system, optionally including the first example, the electric motor comprises a first rotational axis, and the front drive axle comprises a second rotational axis, wherein the first rotational axis is parallel with the second rotational axis. In a third example of the system, optionally including one or both of the first and second examples, the transmission arm assembly is configured to be fastened to a block of the internal combustion engine. In a fourth example of the system, optionally including one or more or each of the first through third examples, the transmission arm assembly comprises a first shaft directly coupled to the rotor shaft, a second shaft rotationally coupled to the first shaft via a first chain, and a third shaft having a first gear mounted thereon, the first gear in mesh with and rotationally coupled to second shaft, the third shaft comprising a drive pinion in mesh with a final reduction gear, and the final reduction gear bolted directly to a differential case of the differential. In a fifth example of the system, optionally including one or more or each of the first through fourth examples, each of the first shaft, the second shaft, the third shaft, and the rotor shaft comprise parallel axes of rotation. In a sixth example of the system, optionally including one or more or each of the first through fifth examples, the transmission arm assembly is configured to utilize splash lubrication. In a seventh example of the system, optionally including one or more or each of the first through sixth examples, the coupling between the internal combustion engine and the generator comprises a link shaft having a first axial length greater than a longitudinal width of a housing of the electric motor. In an eighth example of the system, optionally including one or more or each of the first through seventh examples, the electric motor is mounted distally to the internal combustion engine, where the rotor shaft of the electric motor is arranged at a right angle relative to a crankshaft of the internal combustion engine.

The disclosure also provides support for a vehicle, comprising: a front drive axle comprising a first front wheel and a second front wheel, a differential arranged on the front drive axle, a vehicle frame, a front independent suspension assembly coupling the first front wheel and the second front wheel to the vehicle frame, an internal combustion engine positioned longitudinally to the vehicle, proximally to the front drive axle, and between the front independent suspension assembly, a traction battery, and a power unit, the power unit configured to generate electric power via output of the internal combustion engine, the power unit also configured to supply propulsive effort to the first front wheel and the second front wheel via output of the traction battery, wherein the power unit comprises: a generator positioned longitudinally to the vehicle and distally to the front drive axle and coupled to the internal combustion engine, where a coupling between the internal combustion engine and the generator defines a generator axis, an electric motor positioned transversely to the vehicle and between the internal combustion engine and a distal end of the generator, the electric motor comprising a rotor shaft with a rotor shaft axis that is offset from and perpendicular to the generator axis, and a transmission arm assembly configured to transfer torque between the electric motor and the differential. In a first example of the system, the vehicle frame comprises a first frame rail and a second frame rail that extend longitudinally between a first cross member, a second cross member, and a third cross member, and wherein the first frame rail and the second frame rail angle inward towards a longitudinal centerline of the vehicle. In a second example of the system, optionally including the first example, the first frame rail and the second frame rail form a cavity therebetween, the cavity comprising a first lateral dimension proximate to a front of the vehicle, and a second lateral dimension proximate to a rear of the vehicle, wherein the second lateral dimension is greater than the first lateral dimension. In a third example of the system, optionally including one or both of the first and second examples, the transmission arm assembly comprises at least one gear reduction and at least one chain reduction. In a fourth example of the system, optionally including one or more or each of the first through third examples, the transmission arm assembly comprises a first shaft directly coupled to the rotor shaft, a second shaft rotationally coupled to the first shaft via a first chain, and a third shaft having a first gear mounted thereon, the first gear in mesh with and rotationally coupled to second shaft, the third shaft comprising a drive pinion in mesh with a final reduction gear, and the final reduction gear bolted directly to a differential case of the differential. In a fifth example of the system, optionally including one or more or each of the first through fourth examples, each of the first shaft, the second shaft, the third shaft, and the rotor shaft are centered around parallel axes of rotation.

The disclosure also provides support for a method for a vehicle, comprising: mounting a power unit to an internal combustion engine and coupling the power unit to a front drive axle, the internal combustion engine positioned longitudinally to the vehicle, proximally to the front drive axle, and between a front independent suspension assembly, wherein the power unit comprises a generator positioned longitudinally to the vehicle and distally to the front drive axle and coupled to the internal combustion engine, where a coupling between the internal combustion engine and the generator defines a generator axis, an electric motor positioned transversely to the vehicle and between the internal combustion engine and a distal end of the generator, where a rotor shaft axis is offset from and perpendicular to the generator axis, and a transmission arm assembly configured to transfer torque between the electric motor and the front drive axle. In a first example of the method, the method further comprises: coupling the power unit to a differential arranged on the front drive axle, wherein the power unit is coupled to the differential via the transmission arm assembly. In a second example of the method, optionally including the first example, the transmission arm assembly comprises at least one gear reduction and at least one chain reduction. In a third example of the method, optionally including one or both of the first and second examples, the method further comprises: coupling the generator to the internal combustion engine via a link shaft, the link shaft having first axial length greater than a longitudinal width of a housing of the electric motor. In a fourth example of the method, optionally including one or more or each of the first through third examples, the method further comprises: electrically coupling the power unit to a traction battery.

FIGS. 2-8 show example configurations with relative positioning of the various components. Unless otherwise noted, if shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example.

Note that the example control and estimation routines included herein can be used with various engine and/or vehicle system configurations. The control methods and routines disclosed herein may be stored as executable instructions in non-transitory memory and may be carried out by the control system including the controller in combination with the various sensors, actuators, and other engine hardware. The specific routines described herein may represent one or more of any number of processing strategies such as event-driven, interrupt-driven, multi-tasking, multi-threading, and the like. As such, various actions, operations, and/or functions illustrated may be performed in the sequence illustrated, in parallel, or in some cases omitted. Likewise, the order of processing is not necessarily required to achieve the features and advantages of the example embodiments described herein, but is provided for ease of illustration and description. One or more of the illustrated actions, operations, and/or functions may be repeatedly performed depending on the particular strategy being used. Further, the described actions, operations, and/or functions may graphically represent code to be programmed into non-transitory memory of the computer readable storage medium in the engine control system, where the described actions are carried out by executing the instructions in a system including the various engine hardware components in combination with the electronic controller.

It will be appreciated that the configurations and routines disclosed herein are exemplary in nature, and that these specific embodiments are not to be considered in a limiting sense, because numerous variations are possible. For example, the above technology can be applied to V-6, I-4, I-6, V-12, opposed 4, and other engine types. Moreover, unless explicitly stated to the contrary, the terms “first,” “second,” “third,” and the like are not intended to denote any order, position, quantity, or importance, but rather are used merely as labels to distinguish one element from another. The subject matter of the present disclosure includes all novel and non-obvious combinations and sub-combinations of the various systems and configurations, and other features, functions, and/or properties disclosed herein.

As used herein, the term “approximately” is construed to mean plus or minus five percent of the range unless otherwise specified.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A powertrain, comprising:
a generator positioned longitudinally to the vehicle and distally to the front drive axle and having a generator axis;
an electric motor positioned transversely to the vehicle, the electric motor comprising a rotor shaft having a rotor shaft axis offset from and perpendicular to the generator axis; and
a transmission arm assembly comprising at least one gear reduction and at least one chain reduction, where the transmission arm assembly is configured to transfer torque between the electric motor and a differential arranged on the front drive axle.

2. The powertrain of claim 1, further comprising an internal combustion engine positioned longitudinally to a vehicle and proximally to a front drive axle, the generator coupled to the internal combustion engine, where a coupling between the internal combustion engine and the generator defines the generator axis, wherein the electric motor is interposed between the internal combustion engine and the generator.

3. The powertrain of claim 2, wherein the vehicle comprises a front independent suspension assembly.

4. The powertrain of claim 2, wherein the electric motor comprises a first rotational axis, and the front drive axle comprises a second rotational axis, wherein the first rotational axis is parallel with the second rotational axis.

5. The powertrain of claim 2, wherein the transmission arm assembly is configured to be fastened to a block of the internal combustion engine.

6. The powertrain of claim 2, wherein the transmission arm assembly comprises a first shaft directly coupled to the rotor shaft, a second shaft rotationally coupled to the first shaft via a first chain, and a third shaft having a first gear mounted thereon, the first gear in mesh with and rotationally coupled to second shaft, the third shaft comprising a drive pinion in mesh with a final reduction gear, and the final reduction gear bolted directly to a differential case of the differential.

7. The powertrain of claim 6, wherein each of the first shaft, the second shaft, the third shaft, and the rotor shaft comprise parallel axes of rotation.

8. The powertrain of claim 2, wherein the coupling between the internal combustion engine and the generator comprises a link shaft having a first axial length greater than a longitudinal width of a housing of the electric motor.

9. The powertrain of claim 2, wherein the electric motor is mounted distally to the internal combustion engine, where the rotor shaft of the electric motor is arranged at a right angle relative to a crankshaft of the internal combustion engine.

10. A vehicle, comprising:
a front drive axle comprising a first front wheel and a second front wheel;
a differential arranged on the front drive axle;
a vehicle frame;
a front independent suspension assembly coupling the first front wheel and the second front wheel to the vehicle frame;
an internal combustion engine positioned longitudinally to the vehicle, proximally to the front drive axle, and between the front independent suspension assembly;
a traction battery; and,
a power unit, the power unit configured to generate electric power via output of the internal combustion engine, the power unit also configured to supply propulsive effort to the first front wheel and the second front wheel via output of the traction battery,
wherein the power unit comprises:
a generator positioned longitudinally to the vehicle and distally to the front drive axle and coupled to the internal combustion engine, where a coupling between the internal combustion engine and the generator defines a generator axis;
an electric motor positioned transversely to the vehicle and between the internal combustion engine and a distal end of the generator, the electric motor comprising a rotor shaft with a rotor shaft axis that is offset from and perpendicular to the generator axis; and
a transmission arm assembly configured to transfer torque between the electric motor and the differential.

11. The vehicle of claim 10, wherein the vehicle frame comprises a first frame rail and a second frame rail that extend longitudinally between a first cross member, a second cross member, and a third cross member, and wherein the first frame rail and the second frame rail angle inward towards a longitudinal centerline of the vehicle.

12. The vehicle of claim 11, wherein the first frame rail and the second frame rail form a cavity therebetween, the cavity comprising a first lateral dimension proximate to a front of the vehicle, and a second lateral dimension proximate to a rear of the vehicle, wherein the second lateral dimension is greater than the first lateral dimension.

13. The vehicle of claim 10, wherein the transmission arm assembly comprises at least one gear reduction and at least one chain reduction.

14. The vehicle of claim 10, wherein the transmission arm assembly comprises a first shaft directly coupled to the rotor shaft, a second shaft rotationally coupled to the first shaft via a first chain, and a third shaft having a first gear mounted thereon, the first gear in mesh with and rotationally coupled to second shaft, the third shaft comprising a drive pinion in mesh with a final reduction gear, and the final reduction gear bolted directly to a differential case of the differential.

15. The vehicle of claim 14, wherein each of the first shaft, the second shaft, the third shaft, and the rotor shaft are centered around parallel axes of rotation.

16. A method for a vehicle, comprising:
mounting a power unit to an internal combustion engine and coupling the power unit to a front drive axle, the internal combustion engine positioned longitudinally to the vehicle, proximally to the front drive axle, and between a front independent suspension assembly,
wherein the power unit comprises a generator positioned longitudinally to the vehicle and distally to the front drive axle and coupled to the internal combustion engine, where a coupling between the internal combustion engine and the generator defines a generator axis;
an electric motor positioned transversely to the vehicle and between the internal combustion engine and a distal end of the generator, where a rotor shaft axis is offset from and perpendicular to the generator axis; and
a transmission arm assembly configured to transfer torque between the electric motor and the front drive axle.

17. The method of claim 16, further comprising coupling the power unit to a differential arranged on the front drive axle, wherein the power unit is coupled to the differential via the transmission arm assembly.

18. The method of claim 17, wherein the transmission arm assembly comprises at least one gear reduction and at least one chain reduction.

19. The method of claim 16, further comprising coupling the generator to the internal combustion engine via a link shaft, the link shaft having first axial length greater than a longitudinal width of a housing of the electric motor.

20. The method of claim 16, further comprising electrically coupling the power unit to a traction battery.
